(19) United States
(12) Patent Application Publication
(10) Pub. No.: US 2009/0322179 A1
(43) Pub. Date: Dec. 31, 2009

(54) STATOR FOR AN ELECTRICAL MACHINE

(76) Inventors: Werner Rieker, Waldenbuch (DE); Michael Rader, Oberriexingen (DE)

Correspondence Address: MICHAEL J. STRIKER, 103 EAST NECK ROAD, HUNTINGTON, NY, 11743, US

(21) Appl. No.: 12/375,996

(22) PCT Filed: Oct. 26, 2007
(86) PCT No.: PCT/EP2007/061509

§ 371 Date: Feb. 2, 2009

(30) Foreign Application Priority Data
Nov. 24, 2006 (DE) 10 2006 055 519.8

(51) Int. Cl. H02K 3/48; H02K 3/34

(52) U.S. Cl. 310/215

(57) ABSTRACT

The invention describes a stator for an electrical machine, in particular a universal motor, comprising a stator core (20) with a stator yoke (22) and at least two pole shoes (21), which are arranged radially on the stator yoke (22), and a stator winding (30) with at least two coil windings (31), wherein each pole shoe (21) accommodates at least one coil winding (31), characterized in that the coil windings (31) are connected cohesively to the stator core (20) by means of an adhesive.

### BACKGROUND INFORMATION

The present invention relates to a stator for an electrical machine, in particular for a universal motor, according to the definition of the species in claim 1.

It is already known and has been described, e.g. in EP 1 530 280 A2, to insert the coil windings of a stator winding into the slots of the stator. The coil windings are wound around the pole shoe as tightly as possible. Due to the special shape of the pole shoe, the coil windings in the slots form an undercut, thereby resulting in a certain mechanical stiffness between the coil windings and the iron core of the stator. A sufficiently secure seat of the coil windings in the slots is absolutely necessary in order to ensure smooth operation of the electric motor.

When an electric motor having a stator of this type is exposed to strong vibrations, the operation of the electric motor reflects the fact that the seat of the coil windings in the grooves is not adequately secure. This is observed, in particular, in electric motors in power tools, such as angle grinders and rotary hammers, which are equipped with means for reducing vibrations, such as a vibration-damped housing or a vibration-damped auxiliary handle. These means increase the user-friendliness of the power tool, because fewer vibrations are transferred to the operator via the housing and the handle. At the same time, however, the components, in particular the massive components, in the housing of the power tool, e.g., the electric motor, are exposed to vibrations to a greater extent. As a result of strong vibrations, the coil windings in the slots may come loose and result in failure of the electric motor.

It is also known to also wedge the coil windings in the slots of the stator using shaped parts, thereby resulting in an additional hold via a form-fit connection. A relatively great deal of effort in terms of process engineering is required to insert shaped parts into the slots, and is therefore not a satisfactory solution to the problem.

### DISCLOSURE OF THE INVENTION

The stator according to the present invention makes it possible to attain a stronger mechanical hold of the coil windings in the slots. The coil windings do not come loose in the grooves, nor does the electric motor fail, even when there is a high level of vibrations, over a long period of time. This is attained by the fact that the coil windings are not simply placed in the slots of the stator, they are also bonded with the stator core.

The stator according to the present invention, which is designed for use with an electrical machine, in particular for use with a universal motor, includes a stator core having a stator yoke which forms the magnetic return, and at least two pole shoes which are situated radially on the stator yoke. In a two-poled machine having a magnetic north pole and a magnetic south pole, two pole shoes are situated diametrically opposite one another. In a two-pole machine having an internal-rotor design, the pole shoes are situated on the stator yoke in a manner such that they point radially inwardly. Larger numbers of pole pairs are also possible, in the case of which a plurality of north and south poles is situated on the circumference of the stator yoke in an alternating manner. The stator core is typically composed of a packet of laminations which are made from the same blank and are situated in rows, axially adjacent to one another.

The stator also includes a stator winding having at least two coil windings, each pole shoe being provided with at least one coil winding. One coil winding is composed of a coil wire having a large number of windings. The coil wire is wound in the appropriate shape to form a coil winding. The fully wound coil winding is placed in the slots of the stator, around the pole shoe.

In order to manufacture the stator according to the present invention having a bonded connection between the stator winding and stator core, an adhesive is preferably applied before the stator winding is placed in the slot of the stator core. As an alternative, the stator winding may also be provided with an adhesive. Finally, it is also possible to apply an adhesive to the two surfaces to be connected, i.e. the slot and the coil winding. The adhesive may be applied across the entire surface or only in certain points. When the coil winding is placed in the slots of the stator core, the coil winding is therefore also connected to the stator core via an adhesive.

The adhesive also provides additional electrical insulation for the stator winding against the stator core.

In terms of process engineering, the adhesive provides the advantage that it may be applied to the slots easily and cost-effectively. The additional material expense is minor and relatively cost-effective.

The adhesive must fulfill particular requirements in order to provide an additional mechanical hold for the coil winding in the slots of the stator. For example, the adhesive must be able to ensure a sufficient mechanical hold of the coil windings in the slots even at high temperatures with peaks of up to 180-200° C., as may occur during operation of an electrical motor used in a hand-held power tool. In addition, once the the stator core—which is composed of lamination packets—has been manufactured via punch packing, it is usually covered with lubricating grease, lubricating oil, or the like. The adhesive must therefore provide a secure hold under these conditions as well.

A solvent-free, oxide-filled, thermosetting, single-component adhesive which is based on epoxy resin is particularly well-suited for use as the adhesive.

The coil windings are preferably provided with an insulation element to insulate them electrically against the stator core. The insulation element is preferably composed of paper or pressboard. For this purpose, the coil winding is enclosed in an insulation paper in the region of the slot. The insulation paper may be uncoated, or it may be coated, e.g. with a plastic film.

The coil wire of the coil windings may also be coated, e.g. with a known stove lacquer. After the coil windings, including the insulation paper, are placed in the slots of the stator, the coil wire is warmed, e.g. by directing current through the coil wire. Warming the coil wire causes the stove lacquer to melt, thereby bonding the windings of the coil winding together.

In addition, the coil windings may be coated with a powder coating to provide electrical insulation. Powder coatings of this type have been known from the prior art for a long time. The powder coating is applied to the coil winding by spraying, and is then warmed, which melts it onto the coil winding. As an alternative, the powder coating may also be applied via immersion. In this process, the warmed coil winding is lowered into an immersion bath of the powder coating, thereby melting the powder onto the warmed regions of the coil winding.

In addition, a resin for laminates may also be applied to the stator winding. The resin for laminates is used primarily to protect the stator winding against dust and abrasive particles which enter the housing during operation of a hand-held power tool, e.g. with the cooling air.

A further object of the present invention is an electrical motor which contains a stator according to the present invention. The electrical machine is a universal motor in particular.

The present invention is explained in greater detail below with reference to the attached drawing.

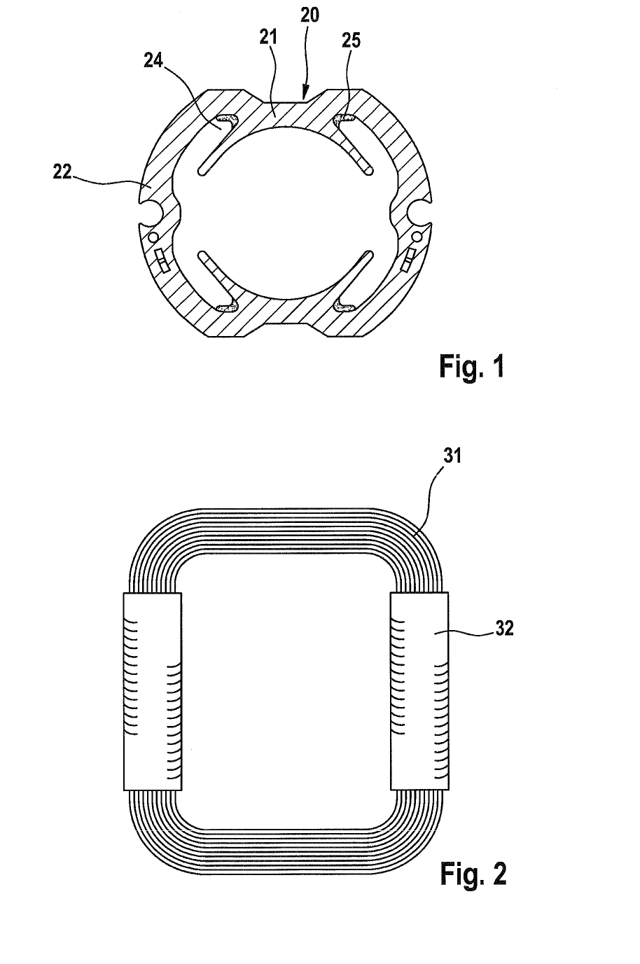

FIG. 1 shows an embodiment of a stator core of a stator according to the present invention

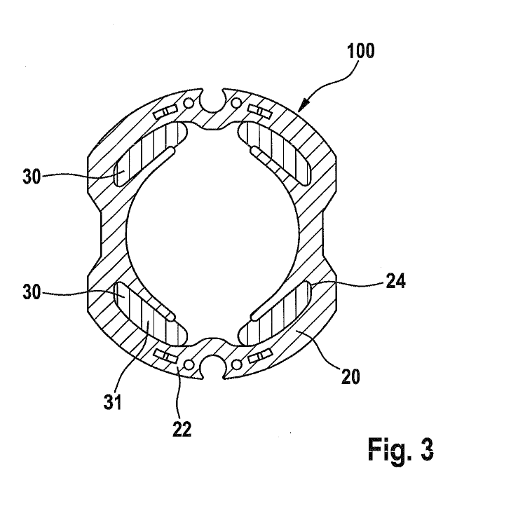

FIG. 2 shows a coil winding

FIG. 3 shows an embodiment a stator according to the present invention.

FIG. 1 shows a stator core 20 of a stator 100, according to the present invention, of a two-poled motor, in particular a universal motor, in a cross-sectional view. Stator core 20 is composed of a stator yoke 22 which forms the magnetic return. Two pole shoes 21 which point radially inwardly are located on stator yoke 22. Pole shoes 21 are diametrically opposed to one another. Slots 24 are formed between pole shoes 21 and stator yoke 21, which are used to accommodate a stator winding 30. Stator core 20 is composed of a packet of laminations which are made from the same blank and are situated in rows, axially adjacent to one another. Stator 100 also includes one stator winding 30 which is composed of at least two coil windings 31 when it is designed for use in a two-poled motor. At least one coil winding 31 is accommodated by one pole shoe 21. One coil winding 31 is composed of a coil wire having a large number of windings. The coil wire is wound to form an approximately rectangular coil winding 31. To provide electrical insulation against stator core 20, coil winding 31 is wrapped, in the region of slots 24, in an insulation element 32, e.g. insulation paper.

Before coil windings 31 are placed in slots 24 of stator core 20, an adhesive 25 which brings about a bonded connection between stator core 24 and stator winding 30 is applied in slots 24. Finally, coil windings 31 which are wrapped in insulation elements 32 are placed in slots 24 of stator core 20.

What is claimed is:

1. A stator for an electrical machine, in particular a universal motor, which includes a stator core (20) comprising a stator yoke (22), at least two pole shoes (21) which are situated radially on the stator yoke (22), and a stator winding (30) having at least two coil windings (31), each pole shoe (21) accommodating at least one coil winding (31),
wherein
the coil windings (31) are bonded with the stator core (20).

2. The stator as recited in claim 1,
wherein
the coil windings (31) are connected to the stator core (20) via adhesive bonding.

3. The stator as recited in claim 2,
wherein
the adhesive is an oxide-filled, thermosetting, single-component adhesive based on epoxy resin.

4. The stator as recited in claim 1,
wherein
the coil windings (31) are provided with an insulation element (32).

5. The stator as recited in claim 4,
wherein
the insulation element (32) is composed of paper.

6. The stator as recited in claim 1,
wherein
the stator core (20) is composed of a packet of axially adjacent laminations.

7. An electrical machine, in particular a universal motor, which contains a stator as recited in claim 1.
